(19) United States
(12) Patent Application Publication
(10) Pub. No.: US 2017/0172173 A1
(43) Pub. Date: Jun. 22, 2017

(54) THERMOREGULATED DEVICE FOR MODIFYING THE CONSISTENCY OF A COMPOSITION AND METHOD FOR OPERATING THE DEVICE

(71) Applicant: CEDRA S.A., 1211 Genéve 12 (CH)

(72) Inventors: THIERRY NAVARRO, Gland (CH); FLORENT JUNOD, Veigy-Foncenex (FR)

(73) Assignee: CEDRA S.A., 1211 Genéve 12 (CH)

(21) Appl. No.: 15/118,364

(22) PCT Filed: Feb. 11, 2015
(86) PCT No.: PCT/IB2015/000138

§ 371 Date: Aug. 11, 2016

(30) Foreign Application Priority Data
Feb. 14, 2014 (IB) PCT/IB2014/000163
Sep. 12, 2014 (IB) PCTIB2014/001816
Sep. 25, 2014 (IB) PCT/IB2014/001918
Oct. 8, 2014 (IB) PCT/IB2014/002056

(51) Int. Cl. A23G 9/12; B01F 11/00; B01F 15/06; A23G 9/22; A23G 9/04

(52) U.S. Cl. CPC A23G 9/12; A23G 9/224; A23G 9/045; B01F 15/065; B01F 11/0065; B01F 2015/061; B01F 2215/0021

(57) ABSTRACT

The invention relates to a thermoregulated device for modifying the consistency of a starting composition that comprises a preparation at least partially mixed with a liquid. For this purpose, the device is configured to accommodate a reservoir (3; 203; 303; 403; 503; 603; 703) containing the starting composition and possessing two opposing faces, at least one of which comprises a flexible section, the device comprising a thermoregulated element (2; 202; 302; 402) having a predefined contact surface arranged to come into contact with one of the opposing faces of the reservoir (3; 203; 303; 403; 503), as well as stirring means for mixing the composition in the reservoir (3; 203; 303; 403). The stirring means comprise a mixer (10; 210; 310; 410) as well as driving means (30; 230; 330) arranged for running the mixer (10; 210; 310; 410) bearing on said flexible section of the reservoir (3; 203; 303; 403; 503), when the reservoir is disposed on the thermoregulated, element (2; 202; 302; 402) of the device, in such a way as to create a local compression zone (8; 208; 308) in the interior of the reservoir (3; 203; 303; 403; 503). The driving means (30; 230; 330) are also arranged to then displace the mixer (10; 210; 310; 410) with respect to the flexible section of the reservoir (3; 203; 303; 403; 503) in order to displace said local compression zone (8; 208; 308) to the interior of the reservoir (3; 203; 303; 403; 503) in such a way as to mix the composition of the reservoir (3; 203; 303; 403; 503) during the mixing operation.

### TECHNICAL FIELD

The present invention relates to a thermoregulated device for modifying the consistency of a starting composition that comprises a preparation at least partially mixed with a liquid, notably for the rapid, simple and low-cost confection of ice cream or any other type of ice.

The device in accordance with the invention is more particularly configured to accommodate a reservoir containing a starting composition and possessing two opposing faces, at least one of which comprises a flexible section. The device comprises a thermoregulated element having a predefined contact surface arranged to come into contact with one of the opposing faces of the reservoir, as well as stirring means for mixing the starting composition in the reservoir. The temperature of the composition contained in the reservoir is modified by conduction with the thermoregulated element during the mixing operation in order to obtain a final composition of modified consistency.

The present invention also relates to a method for operating the thermoregulated device as well as a reservoir suitable for use with the device.

### PRIOR ART

There exist numerous ice preparation systems and methods, notably refrigerated mixers such as are marketed under the name “Mantecatore” or ice cream machine. These systems of conventional type consist in pouring an ice preparation in powder form mixed with water into a refrigerated tank. A stirring element is activated to cool the ice preparation by contact with the interior of the tank until a frozen mass is obtained. The ice formed in this way also contains air bubbles trapped in the chilled mass during mixing. One of the disadvantages encountered with these conventional systems stems from the fact that the tank and the stirring element are in direct contact with the ice, which makes their use a nuisance since it is necessary to clean them and to disinfect them regularly. Moreover, these systems have the disadvantage of leaving residual ice on the stirring element that it is necessary to remove to prevent losses. Moreover, the ice preparation time is relatively long because only a small portion of the mass is in contact with the interior of the tank.

The ice preparation time starting from a preparation may be reduced by directly pouring the liquid or semi-liquid mixture of the preparation onto a cold plate, the effect of which is to chill the mass quickly to produce the ice. This method is known as “fried ice cream”.

Another means for rapid fabrication of ice cream consists in mixing the ice preparation directly with liquid nitrogen which makes it possible to produce an ice cream in one minute with no refrigerated tank.

The problem encountered with these methods is that they are carried out manually. Another problem is that the chilling plate and the ice manipulation accessories must be cleaned regularly or after each use if it is required to change the type or flavor of the ice.

Liquid nitrogen ice also gives rise to the problem of supplying the liquid nitrogen, the risk of serious frostbite linked to manipulating it and the high unit cost of the ice.

The ice preparation system described in EP 2 266 417 makes it possible to produce an ice using a prefilled flexible reservoir placed between a mixer element and a chilling element. It also features different ways of emptying the reservoir and a method associated with the complete process. The system described does not show precisely how to produce an ice rapidly, however, for example in less than 3 minutes. In fact, the principal benefit of an individual portion ice machine lies in a very short composition time in order to avoid waiting and to be able to serve a greater number of persons quickly. Moreover, no precise way to produce the mixing is described in EP 2 266 417, which makes the number of possible embodiments high without guaranteeing a satisfactory result as to the quality and the exit temperature of the ice. Moreover, the mixing means in accordance with the above document include scratching, scraping, crushing and kneading the reservoir, which have the disadvantage of creating wear of the reservoir and risks of tearing associated with the friction inherent to mechanisms of these types, particularly if the mixture solidifies. Another disadvantage of this system stems from its construction, which comprises a mixing unit, an opening unit and an extraction unit that are separate, which makes it complicated to produce, to control and to miniaturize. Moreover, the associated method consists in activating the chilling system at the same time as mixing, which has the disadvantage of considerably increasing the preparation time. This method also includes a de-icing step that also increases the waiting time before the preparation of the next portion. Finally, the use of a prefilled bag associated with the system is bulky and costly for transportation and storage.

The ice preparation system described in WO2014067987 makes it possible to produce an ice from a reservoir in the form of a cup prefilled with powder or a mixture ready for use placed in a chilled conical counter-form. A mixer element prepositioned in the reservoir is fixed to an external drive system moving in a circular manner in order to stir the content at the same time as chilling it. An air extraction system makes it possible to reduce the layer of air between the reservoir and the chilling element in order to optimize the thermal transfer. This system has the disadvantage of a longer time for thermal transfer between the cold element and the mixture than with a flat bag for the same mixing volume. A second problem concerns the profile and the mechanical strength of the mixer element enabling regular, uniform, rapid stirring during the phase of solidification of the mixture. The development of a system of this kind therefore proves complex and it is uncertain if a portion of ice can be produced in less than 3 minutes. The system moreover necessitates a de-icing element that increases the waiting time before the preparation of the next portion. Finally, the use of a cup prefilled with an integrated mixer element has the disadvantage of being bulky for transportation and storage.

### DISCLOSURE OF THE INVENTION

A principal object of the present invention is therefore to propose a thermoregulated device for modifying the consistency of a composition, notably for the confection of ice cream, that remedies the disadvantages of the prior art.

To this end, the present invention more particularly concerns a thermoregulated device of the type mentioned above, characterized in that the stirring means comprise a mixer as well as driving means arranged for bringing the mixer to bear on the flexible section of the reservoir, when the latter is disposed on the thermoregulated element of the device, in such a way as to create a local compression zone in the interior of the reservoir. The driving means in accordance with the invention are also arranged to then move the mixer with respect to the flexible section of the reservoir in order to move said local compression zone inside the reservoir in such a way as to mix the composition contained in the reservoir.

The present invention also concerns a thermoregulated device of the type mentioned above, characterized in that it further comprises a thermoinsulating membrane adapted to be able to be moved relative to the thermoregulated element. The thermoinsulating membrane is preferably arranged so as to cover the face of the reservoir including the flexible section when the reservoir is disposed on the thermoregulated element and the device is brought into a closed configuration.

Thanks to these features, the device enables the confection of cold preparations, notably milkshake, ice or ice cream in a rapid and simple manner and at low production cost. The device is particularly suitable for domestic use in a kitchen in the form of a consumer domestic appliance such as an ice machine. It is also perfectly suited to any other professional use in the fields of restauration, foodstuffs and industry for the preparation of mixtures of other types in a flexible reservoir by all or part of the fabrication method described hereinafter. The system is designed to be small in size and light in weight and to use a minimum number of components in order to be easily transportable.

The present invention further concerns a method for operating the thermoregulated device notably including the following steps:
i. activation of the thermoregulated device;
ii. modification of the temperature of the thermoregulated element of the device;
iii. positioning of a reservoir in contact with the thermoregulated element, the reservoir possessing at least one flexible section and containing a starting composition;
iv. moving the mixer to bring it to bear on said flexible section of the reservoir in such a way as to create a local compression zone inside the reservoir;
v. moving the mixer with respect to the flexible section of the reservoir in order to move said local compression zone inside the reservoir in such a way as to mix the composition in the reservoir during a mixing operation; and
vi. extracting a final composition of transformed consistency from the reservoir.

### BRIEF DESCRIPTION OF THE DRAWINGS

The present invention will be better understood on reading the description of examples given by way of nonlimiting and purely illustrative example with reference to the appended drawings, in which:

FIG. 1 represents a perspective view of the device in accordance with a first embodiment of the invention in an open position;

FIG. 2a represents a plan view of FIG. 1;

FIG. 2b represents a view in section taken along the line A-A of FIG. 2a;

FIG. 3 represents a perspective view of the device in a closed position;

FIG. 4a represents a plan view of FIG. 3a;

FIG. 4b represents a view in section taken along the line A-A of FIG. 4a;

FIG. 5a represents a side view of FIG. 3;

FIG. 5b represents a view in section taken along the line B-B of FIG. 5a;

FIG. 5c represents a diagrammatic view in section of the device in the closed position and connected to complementary elements;

FIG. 5d represents a diagrammatic view in section of the device in the closed position with a reservoir comprising thermal insulation;

FIG. 5e represents a diagrammatic view in section of the device in the closed position comprising thermal insulation in contact with the reservoir;

FIG. 5f represents a diagrammatic view in section of the device in the closed position comprising thermal insulation in contact with the thermoregulated element;

FIG. 6 is a diagrammatic representation regarding the operation of the device;

FIG. 7 represents a perspective view of the device in accordance with a second embodiment of the invention;

FIG. 8 represents a side view of FIG. 7;

FIG. 9 represents a plan view of FIG. 7;

FIG. 10 represents a view in section taken along the line A-A of FIG. 9;

FIG. 11 represents a perspective view of the device in accordance with a third embodiment of the invention;

FIG. 12a represents a plan view of the device in accordance with a fourth embodiment of the invention during a mixing operation;

FIG. 12b represents a view similar to FIG. 12a when the device is being emptied;

FIG. 12c represents a view similar to FIG. 12b when the device is in the final stage of being emptied;

FIG. 13 is a perspective view of a preferred variant of the reservoir;

FIG. 13a is a perspective view of another variant of the reservoir; and

FIG. 14 is a plan view of a variant of the reservoir of rectangular shape; and

FIG. 15 is a plan view of a variant of the reservoir of circular shape.

### EMBODIMENTS OF THE INVENTION

In the following description relating to a number of embodiments of the invention, by “reservoir” is meant any container suitable for use with the thermoregulated device in accordance with the invention, notably including at least one flexible section, the container preferably being in the form of a flexible sachet, pouch or bag.

Moreover, the device in accordance with the invention is configured to receive either a prefilled reservoir containing a preparation or a substance in powder form premixed with a liquid or a reservoir containing only a preparation or a substance in powder form, the preparation being mixed with a liquid by a liquid injection system integrated into the device before the mixing operation. Whichever option is preferred, a device configured to receive a reservoir containing a starting composition will always be referred to.

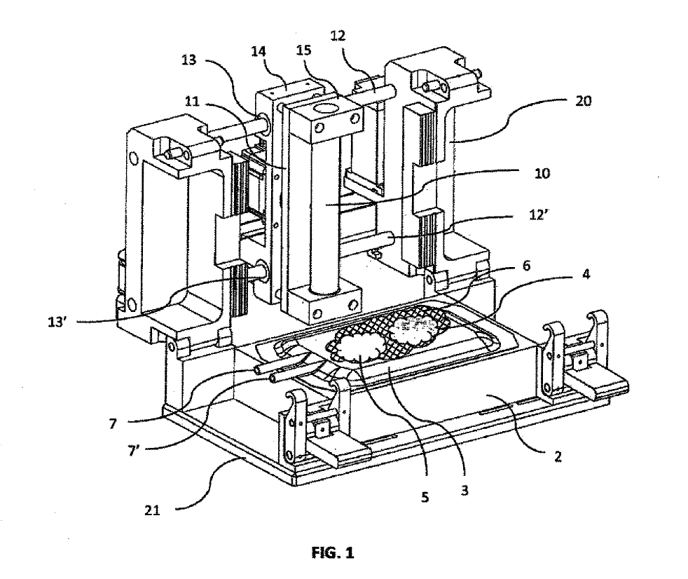

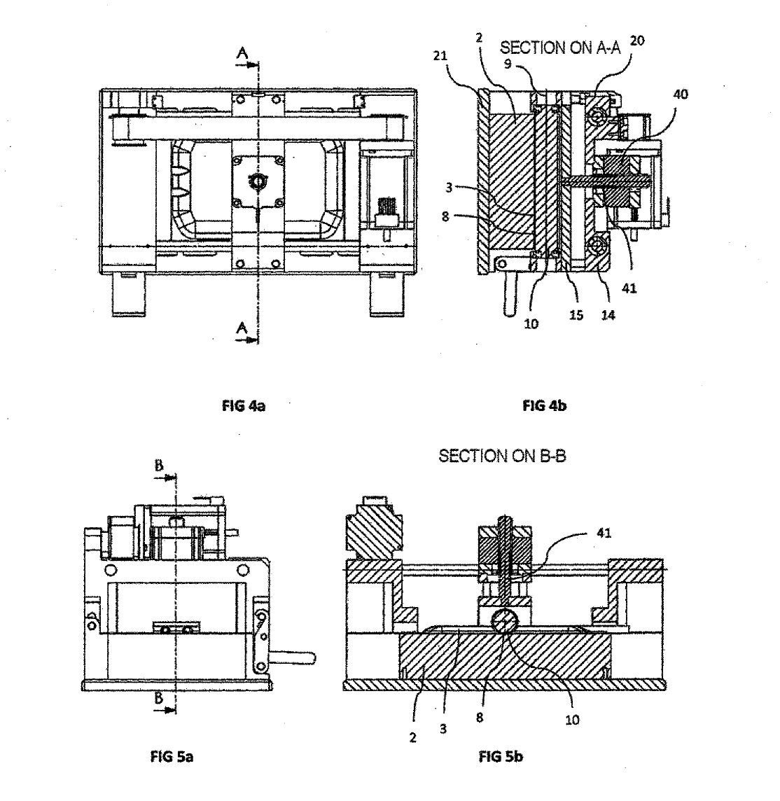

The thermoregulated device in accordance with a first embodiment, as notably illustrated by FIGS. 1, 4b and 5c, includes a thermoregulated element 2 and a mixer 10, preferably in the form of a roller or circular volume rotating freely about its revolution axis 9, respectively placed on a base 21 and a lid 20 that can be opened relative to each other in order to be able to place on the thermoregulated element 2 the reservoir 3 containing a preparation 4 preferably in powder form and/or at least one fluid 5 preferably in liquid form, such as water, for example, and so that the mixer 10 is in contact with the reservoir 3, preferably on its face opposite that in contact with the thermoregulated element 2. The mixer 10 rolls over the reservoir 3 and this prevents the friction that could damage the surface of the reservoir.

At least one fluid 5 may be introduced into the reservoir 3 via at least one opening 7, 7′ of the reservoir 3 when the reservoir is introduced into the device. A fluid transfer element 56, preferably in pump or valve form, may be actuated in a controlled manner, either manually or automatically, in order to fill the reservoir with the required amount of the fluid 5.

The reservoir 3 is preferably closed when in storage and includes one or more opening elements activated upon its insertion into the thermoregulated device, for example in the form of at least one film or wall that can be pierced, detached or peeled off.

At least one valve or closure element of the fluid passage 53 between the fluid transfer element 56 and one of the openings 7, 7′ makes it possible to monitor and to regulate the direction and/or the flow rate and/or the pressure of at least some of the fluid 5 before, during and after its introduction into the reservoir.

The reservoir 3 may contain the preparation 4 in vacuum-packed powder form so as to preserve the preparation 4 in the reservoir 3 without gas. A gas or air may then be added when one of the openings 7, 7′ is connected to the fluid passage 53. The volume of gas or air may be controlled by the fluid transfer element 56 which, by being connected to a plurality of sources of fluid, is able selectively to control the precise volume of each fluid to be introduced into the reservoir before and/or during the movement of the mixer 10.

The mixer 10 is held by a support 15 connected to a carriage 14 via rolling bearings or bearings 13, 13′ sliding along shafts 12, 12′ fixed to the lid 20. The reservoir 3 preferably includes at least one opening 7, 7′, preferably in plastic and/or metal tube or pipe form, used to introduce and/or to extract some or all of the preparation 4 and/or the fluid 5.

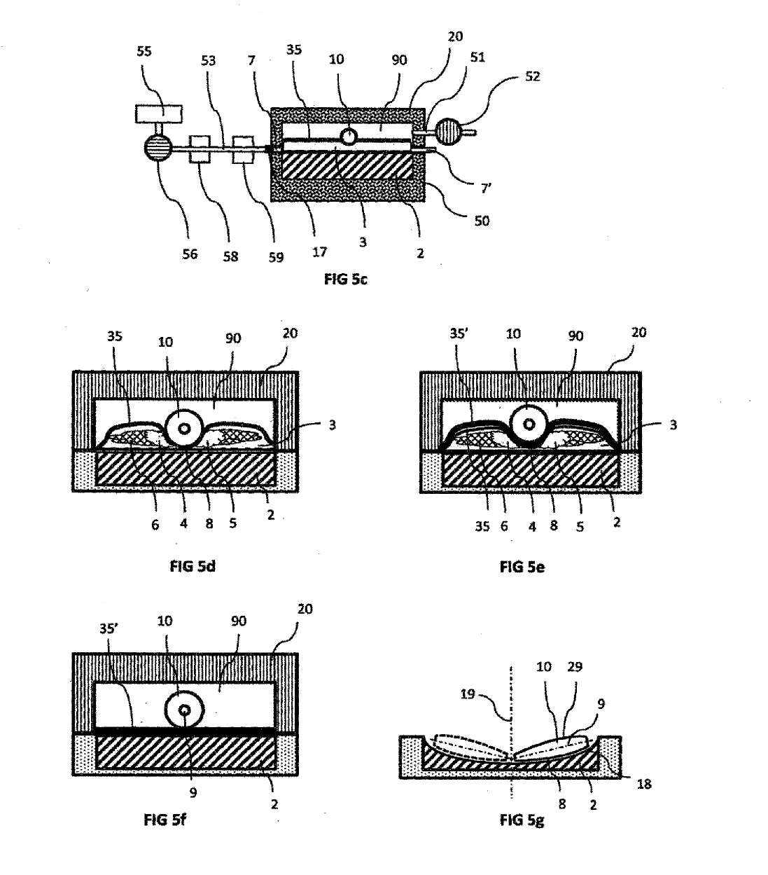

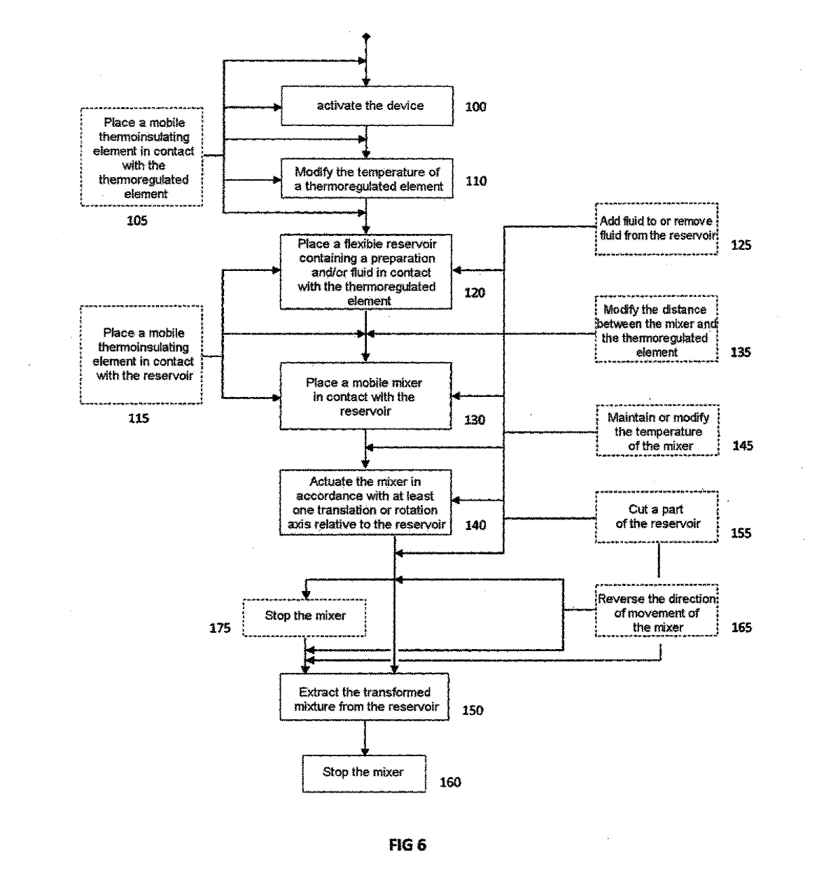

According to FIG. 5d, the reservoir 3 preferably includes a thermally insulative or isothermal covering 35 on its face opposite that in contact with the thermoregulated element 2 so as to insulate the content of the reservoir 3 from the outside temperature and to increase the energy transfer with the thermoregulated element. The thermal insulation layer may be integrated directly into the reservoir 3 or stuck, welded, attached in external manner to the reservoir 3. The thermal insulation element may for example consist of layers of dry and stable air bubbles enclosed in fireproofed polyethylene films covered on each side with a polished aluminum foil a few microns thick.

The thermal insulation may also be made of plastic or other material film having a sufficient thickness on the face of the reservoir in contact with the mixer 10 and/or opposite that in contact with the thermoregulated element 2. In this case, the thicknesses of the walls or faces of the reservoir 3 are different so as to have the smallest thickness in contact with the thermoregulated element 2 and the greatest thickness in contact with the mixer 10.

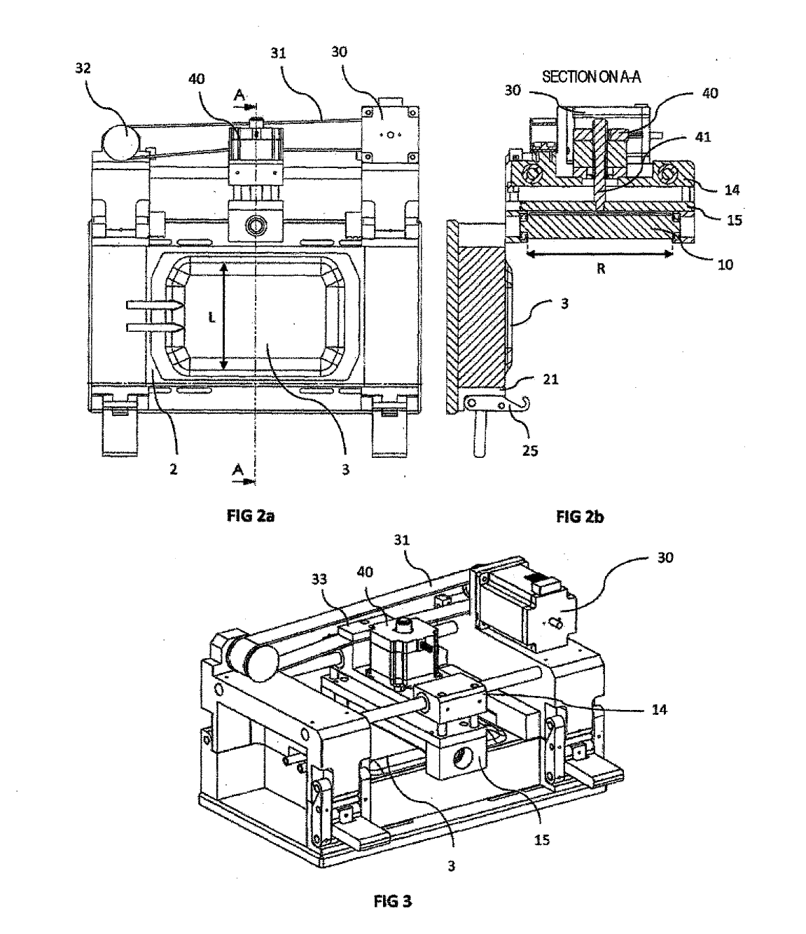

According to FIGS. 2a, 2b and 3, the support 15 is connected to a positioning element 41, preferably in lead screw form, arranged to be driven by an actuator 40, preferably in variable speed motor form, enabling axial movement of the mixer 10 relative to the lid 20. A belt 31, connected to a drive actuator 30, preferably in the form of a motor, and attached to the carriage 14 by means of a fixing 33, turns around a pulley 32 fixed to the support 20 so as to move the carriage 14 parallel to the thermoregulated element 2.

The length R of the mixer 10 coming to bear on the outside of the reservoir 3 corresponds to at least 90% of the maximum bearing distance L of the interior volume of the reservoir 3 between its two opposing faces so that the mixer 10 travels over most or all of the projected area of the interior volume of the reservoir 3 relative to the thermoregulated element 2. The length R is preferably greater than or equal to the maximum bearing distance L. In this way, the mixture/composition 6 is preferably moved entirely by the mixer 10 inside the reservoir 3 in order to render uniform the thermal exchange with the thermoregulated element 2 during stirring/mixing.

According to FIGS. 3, 4a, 4b, 5a and 5b, when the lid 20 is in a closed position, the reservoir 3 is partly compressed by the mixer 10 that comes to bear on the reservoir 3. The distance the mixer 10 is pressed onto the reservoir 3 is adjusted by means of the positioning element 41 moving perpendicularly to the thermoregulated element 2 when the actuator 40 is activated.

A constriction or local compression zone 8, preferably of rectilinear or straight shape, is thus obtained between the mixer 10 and the thermoregulated element 2. This local compression 8 creates a local acceleration and a movement of the fluid upon movement of the mixer 10 relative to the reservoir 3, the effect of which is to mix and to stir/mix the preparation 4 and/or the fluid 5 in the reservoir 3. The speed of relative movement of the mixer 10 on the reservoir 3 is preferably higher at the beginning of the transformation process so as to render uniform the mixture/composition 6 once the fluid 5 is introduced into the reservoir 3. The preparation 4 and the fluid 5 are therefore perfectly mixed in the liquid phase in order to obtain a composition of uniform transformed consistency.

The constriction or local compression zone 8 between the mixer 10 and the thermoregulated element 2 varies with the activation of the actuator 40, which makes it possible to modify at any time the volume of mixture 6 passing under the mixer 10 during stirring/mixing. This adjustment of the constriction or local compression zone 8 is particularly important to prevent excessive compression of the reservoir and to maintain a sufficient stirring/mixing speed when the mixture 6 begins to be transformed into the solid phase. The forces on the mixer 10 and the mechanical assembly increase as the mixture is transformed, which makes it necessary to be able at any time to adjust the speed of the mixer 10 and the force with which it bears on the reservoir 3.

By moving the mixer 10 so as to bring the two walls of the reservoir 3 into contact, it is then possible to empty the reservoir via at least one of the openings 7, 7′. The transformed mixture/composition 6 of the preparation 4 and/or with the liquid 5 can be consumed directly, once extracted from the reservoir 3 in the case of an ice cream or an edible mixture.

If an obstructing element (not shown) closes at least one of the openings 7, 7′ of the reservoir 3 containing the preparation 4 and/or the liquid 5, the to-and-fro or opposite direction movement of the mixer 10 parallel to the thermoregulated element 2 has the effect of mixing the content of the reservoir 3 at the same time as chilling it by conduction with the thermoregulated element 2. It is therefore possible to transform the preparation 4 and/or with the liquid 5 into ice or cold preparation in a clean manner, with no direct contact between the content of the reservoir and the mixer elements or accessories, and quickly thanks to the large conducting area of the reservoir 3 that is against the thermoregulated element 2. Once the ice or the cold composition has formed inside the reservoir 3, the mixer 10 is positioned to bear on the thermoregulated element 2 at the end opposite one of the unobstructed openings 7, 7′ so as to extract the iced/chilled mixture 6 from the reservoir 3 by moving the mixer 10 in the direction of one of the openings 7, 7′. Once emptied, the reservoir 3 may be thrown away, recycled or cleaned for another use, depending on the applications.

According to FIG. 5c, when the lid 20 is closed, the reservoir 3 is preferably situated in a cavity 90 formed between the lid 20 and the thermoregulated element 2 and/or a support 50. The lid 20 and the support 50 preferably comprise all or part of a thermal insulation material so as to form a preferably sealed enclosure that is thermally insulated to reduce the time for the thermoregulated element 2 to reach the required temperature and to prevent energy losses to the surrounding air. A drying and/or air aspiration system 52 is preferably placed to communicate with the cavity 90 via a passage 51 so as to be able to establish a vacuum and/or to monitor, to eliminate moisture in the cavity 90 before, during or after placing the reservoir 3 in the system. It is therefore possible to reduce icing up of the surfaces forming the cavity 90 and that of the thermoregulated element 2.

An external fluid passage 53 is preferably positioned so that it can be connected with the opening 7 and transfer all or some of the fluid 5 from a fluid reservoir 55 on activation of the fluid transfer element 56.

The seal between the fluid passage 53 and the opening 7 may be provided by a seal, a mechanical stress or any other fluid connection means. The opening 7 preferably includes or forms a connector 17 intended to be connected to the fluid passage 53 so as to hold the reservoir 3 in position and/or to guarantee the seal. The connector 17 preferably includes one or more opening elements activated upon its insertion into the system for transforming the mixture or upon its connection to the fluid passage 53, for example in the form of at least one film or wall that can be pierced, detached or peeled off. The connector 17 may also include a valve.

The connector 17 preferably includes a fixing element specific to the connection with the fluid passage 53 such as, for example, a notch, a clip, a catch or any other mechanism for retaining and/or securing the connection.

A thermal transfer element 58, preferably in the form of a chilling element, is placed in the proximity of or against all, or part of the fluid passage 53 in such a manner as to be able to control the temperature of the fluid 5 before and during its introduction into the reservoir 3. It is therefore possible to reduce the transformation time of the mixture, for example by pre-chilling the temperature of the fluid 5 to a temperature below the ambient temperature or that of the fluid reservoir 55. This also makes it possible to adjust the temperature of the fluid 5 to a precise temperature ensuring the conditions required for the proper functioning of the device and the quality of the process of transformation of the mixture 6.

A fluid treatment element 59, preferably in the form of a purification element, a UV radiation or other disinfection element, carbon or other filter element, ionizer or of any other type is placed in the vicinity of or against/in all or part of the fluid passage 53 so as to be able to act on the quantity of germs, bacteria, viruses, fungi, minerals, chemical compounds present in all or part of the fluid 5 before and during its introduction into the reservoir 3. It is therefore possible to control the quality of the fluid 5 in order to prevent any contamination of the mixture 6 by one or more unwanted elements that can degrade the quality and/or the edibility of the mixture 6. This is particularly important if the reservoir is not cleaned regularly or the fluid stagnates or the quality of the fluid introduced into the fluid reservoir 55 is hygienically insufficient.

According to FIGS. 5e and 5f, the thermoregulated device may be adapted to place a preferably flexible thermoinsulating element or layer 35′ between the mixer element 10 and the reservoir 3, for example in the form of a membrane made of neoprene or any other type of deformable thermal insulation. This thermoinsulating element or layer 35′ makes it possible to insulate the thermoregulated element 2 from the surrounding air situated in the cavity 90 in order to reduce the time to bring the thermoregulated element 2 to the required temperature and the time to transfer energy between the thermoregulated element 2 and the content of the reservoir 3. The thermoinsulating element or layer is deformed by the stress imposed by the mixer element and therefore transmits the stirring/mixing movement to the flexible reservoir containing the mixture to be transformed.

According to FIG. 5f, the thermoinsulating element or layer 35′ is preferably fastened to the lid 20 so as to be placed against the thermoregulated element 2 when there is no reservoir 3 in the device. It is therefore possible to eliminate ice over all of the area of the thermoregulated element 2 in contact with the surrounding air.

According to FIG. 5g, the mixer 10 may take the form of a circular volume the profile 29 of which matches the profile 18 of the thermoregulated element 2, which is possibly concave or convex, so as to form a local compression zone 8 of curvilinear shape or of any other shape that is not straight or partly straight. When the mixer 10 turns about an axis 19, it is therefore possible to move it so that its profile 29 traces out/travels over a circular surface parallel to the surface of the thermoregulated element 2 defined in part by the profile 18. The mixer 10 preferably turns freely about its revolution axis 9. All or part of the profile 29 of the mixer 10 is preferably identical to all or part of the profile 18 of the thermoregulated element. It is equally possible to oil or to grease the surface of the thermoinsulating element 35′ on its face in contact with the mixer 10 in order to reduce friction and wear of the thermoinsulating element 35′.

Transformation of the mixture/composition 6 from the liquid phase to the solid phase for the preparation of a portion of ice preferably between 100 g and 180 g inclusive in less than 3 minutes necessitates a plurality of parameters preferably including:
thermal insulation situated on the face of the reservoir opposite that in contact with the thermoregulated element,
an area of contact between at least one thermoregulated element and a face of the reservoir between 70 and 600 cm²,
a thickness of the surface of the reservoir in contact with at least one thermoregulated element between 0.1 and 0.5 mm inclusive,
a temperature of the thermoregulated element before and/or during contact with a face of the reservoir less than −20° C.,
a thickness of the thermoregulated element in contact with a face of the reservoir less than 10 mm,
a variable constriction or local compression zone distance between the mixer and the thermoregulated element less than 10 mm,
a length over which the mixer bears on the reservoir to form the constriction or local compression zone between 3 and 20 cm inclusive,
a respective proportion of preparation and of fluid constituting the mixture to be transformed between one quarter and one half, and
a variable speed of movement of the mixer bearing on a face of the reservoir.

According to FIG. 6, the method for operating the device in accordance with the invention comprises the following successive steps:
a step 100 consisting in activating the device,
a step 110 consisting in modifying the temperature of the thermoregulated element to an operating temperature that is preferably preprogrammed,
a step 120 consisting in placing a reservoir having at least one flexible section containing a preparation, with or without fluid preferably in liquid and air form, in contact with a thermoregulated element, preferably pre-chilled to a temperature below −20° C.,
a step 130 consisting in placing the mixer in contact with the reservoir,
a step 140 consisting in actuating the mixer moving along at least one axis of rotation or translation relative to the reservoir,
a step 150 consisting in extracting the mixture from the reservoir once the transformation is finished,
a seventh step 160 consisting in stopping the mixer.

It is then possible to remove the reservoir and to restart the cycle at the step 110 or 120 according to the temperature of the thermoregulated element.

A plurality of intermediate and optional steps (inside chain-dotted line in FIG. 6) make it possible to improve, simplify and optimize the transformation process in order to speed up the device and make it more compact and more efficient, notably:
a step 105 consisting in placing a mobile thermoinsulating element in contact with the surface of the thermoregulated element exposed to the surrounding air. This thermoinsulating element may be placed at different times before the insertion of the reservoir into the system so as to reduce the time to change the temperature of the thermoregulated element and to prevent the formation of ice on the thermoregulated element;
a step 115 consisting in placing a thermoinsulating element, preferably identical to that used for the step 105, in contact with the surface of the reservoir opposite that of the reservoir in contact with the thermoregulated element so as to insulate a portion of the reservoir from the surrounding air and thereby to improve the transfer of energy between the thermoregulated element and the content of the reservoir;
a step 125 consisting in introducing fluid into the reservoir or withdrawing it therefrom via a fluid transfer element connected to an opening of the reservoir by a fluid passage. Fluid may be added to or removed from the reservoir at any time once the reservoir is connected to the fluid transfer element;
a step 135 consisting in varying the force with which the mixer bears on the reservoir, corresponding to a variation of the distance between the mixer and the thermoregulated element. This distance may vary at any time once the mixer is in contact with the reservoir;
a step 145 consisting in modifying the temperature of the thermoregulated element if necessary in order to act on the speed of energy transfer between the thermoregulated element and the content of the reservoir. This step may be activated as soon as the device is activated so as to monitor the temperature of the thermoregulated element and to maintain it in accordance with a manual or automatic setpoint;
a step 155 consisting in opening the reservoir by cutting a portion of the reservoir, preferably at the level of one of the openings, so as to be able to extract the mixture from the reservoir. This step may be executed at any time once the reservoir is placed in the device;
a step 165 consisting in reversing the direction of movement of the mixer to create a to-and-fro movement for stirring/mixing the mixture, extracting the mixture or moving to a specific position;
a step 175 consisting in stopping the mixer before extracting the mixture. This step is preferred if the extraction system requires the mixer to be stopped but is not obligatory if the mixer combines the function of extraction of the mixture.

The transformation of the mixture by this method therefore makes it possible to produce a cold preparation, an ice or ice cream rapidly on demand. The transformed mixture is preferably extracted from the reservoir when its temperature is below −4° C. The reservoir may be stored at room temperature, avoiding the need to store the cold preparation or the ice in the refrigerator or freezer before consuming it, which necessitates a large amount of energy for storage and transport to the consumption site.

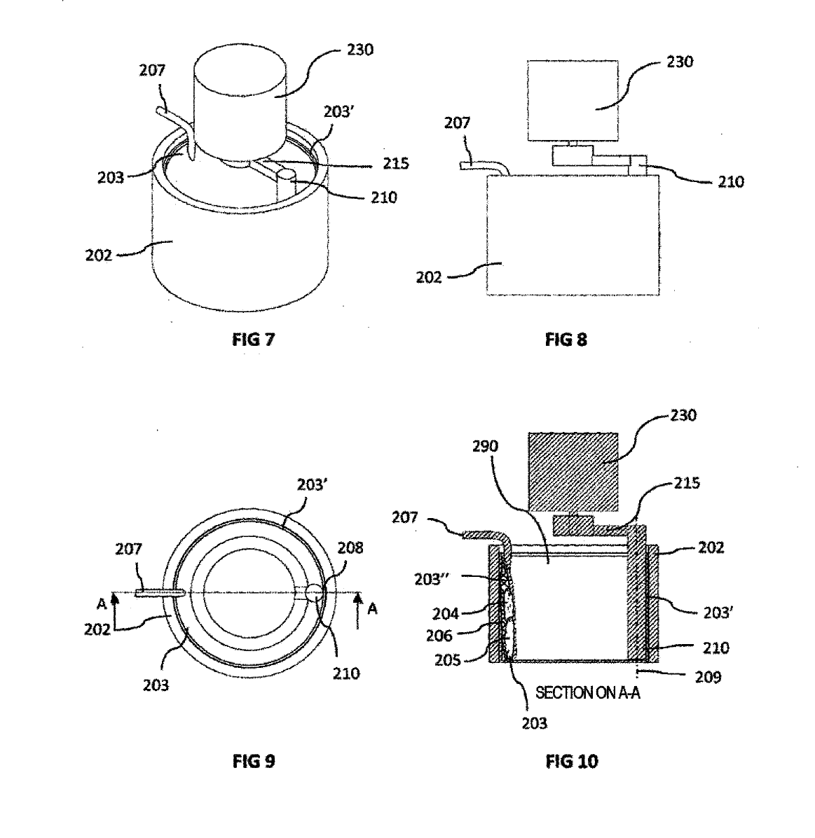

The thermoregulated device in accordance with a second embodiment of the invention, as illustrated by FIGS. 7 to 10, includes a thermoregulated element 202 and a mixer 210, preferably in the form of a roller or circular volume turning freely on its revolution axis 209, retained by a support 215 fixed to a motor 230. The reservoir 203, preferably in the form of a circular volume or flattened torus, containing the preparation 204 and/or a fluid 205 is placed against the thermoregulated element 202, preferably in the form of a cylinder or any other concave or convex shape enabling contact with the reservoir 203. The mixer 210 is preferably placed inside the cavity 290 so as to come to bear on the reservoir 203 and to form with the thermoregulated element 202 a local compression zone, preferably of rectilinear or straight shape, in the reservoir 203.

When the motor 230 turns, the mixer 210 is moved relative to the reservoir 203 which creates a movement and a local acceleration of the preparation 204 and/or of the fluid 205 in the reservoir 203 the effect of which is to mix and to stir the content of the reservoir at the same time as a thermal exchange is produced by the contact of the reservoir 203 with the thermoregulated element 202. The preparation 204 and/or the liquid 205 can therefore, in the same manner as described above, be mixed and transformed into a mixture 206 in the form of ice or cold preparation. At least one opening 207 communicating with the reservoir 203 makes it possible to introduce or to withdraw some or all of the preparation 204 and/or the fluid 205 and/or the mixture 206 before, during or after the transformation of the mixture.

The relative position of the thermoregulated element 202 with the mixture 210 may be varied by moving the motor 230 and/or the thermoregulated element 202, by means of at least one mechanism that is not shown, so as to be able to vary the constriction or local compression zone 208 on the reservoir 203 between the thermoregulated element 202 and the mixer 210.

The reservoir 203 optionally comprises a rigid or semi-rigid structure 203′ of goblet or cup shape that can be used to receive the mixture 206 directly after transformation by removing all or part of the flexible section 203″ of the reservoir 203. It is then no longer necessary to transfer the mixture 206 into another container, which makes the system particularly suitable for the production of takeaway ice that is clean, rapid, economic and ecological.

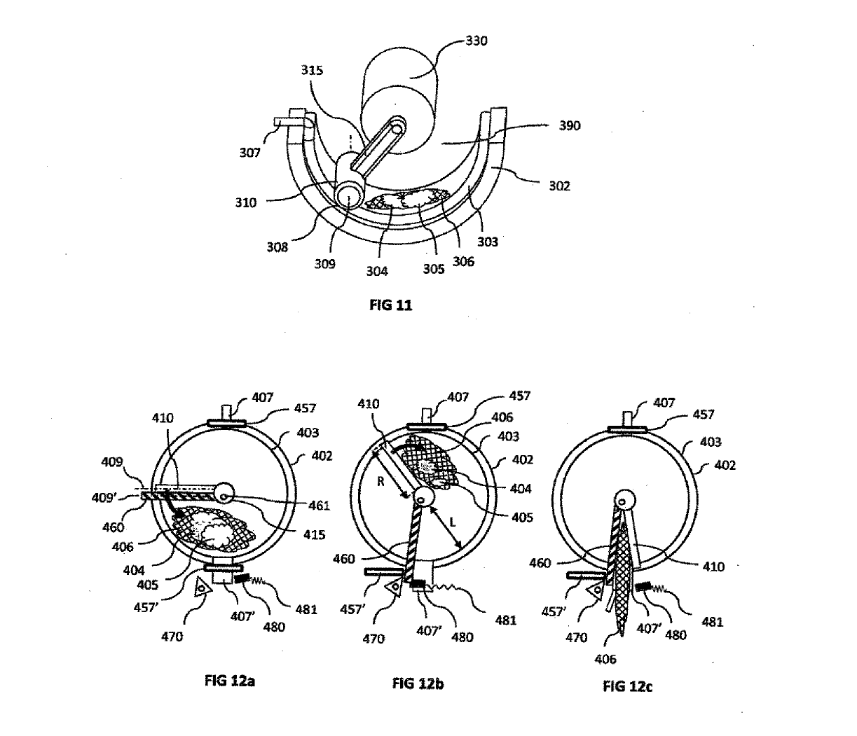

The thermoregulated device in accordance with a third embodiment of the invention, as illustrated by FIG. 11, includes a thermoregulated element 302 and a mixer 310, preferably in the form of a roller or circular volume turning freely about its revolution axis 309, retained by a support 315 fixed to a motor 330. The reservoir 303 containing the preparation 304 and/or a fluid 305 is placed against the thermoregulated element 302, preferably of part-cylindrical shape or of any other concave or convex shape enabling contact with the reservoir 303. The mixer 310 is preferably placed inside the opening 390 so as to come to bear on the reservoir 303 and form with the thermoregulated element 302 a compression zone, preferably of rectilinear or straight shape, in the reservoir 303.

When the motor 330 turns or reciprocates, the mixer 310 is moved relative to the reservoir 303 which creates a movement and a local acceleration of the preparation 304 and/or the fluid 305 in the reservoir 303 the effect of which is to mix and stir the content of the reservoir at the same time as a thermal exchange is produced by the contact of the reservoir 303 with the thermoregulated element 302. The preparation 304 and/or the liquid 305 can therefore, in the same manner as described above, be mixed and transformed into a mixture 306 in the form of ice or cold preparation. At least one opening 307 makes it possible to introduce or to withdraw some or all of the preparation 304 and/or the fluid 305 and/or the mixture 306 before, during or after the transformation of the mixture.

The relative position of the thermoregulated element 302 with respect to the mixer 310 can be varied by moving the motor 330 and/or the thermoregulated element 302 by means of at least one mechanism that is not shown so as to be able to cause the constriction or local compression zone 308 on the reservoir 303 between the thermoregulated element 302 and the mixer element 310 to vary.

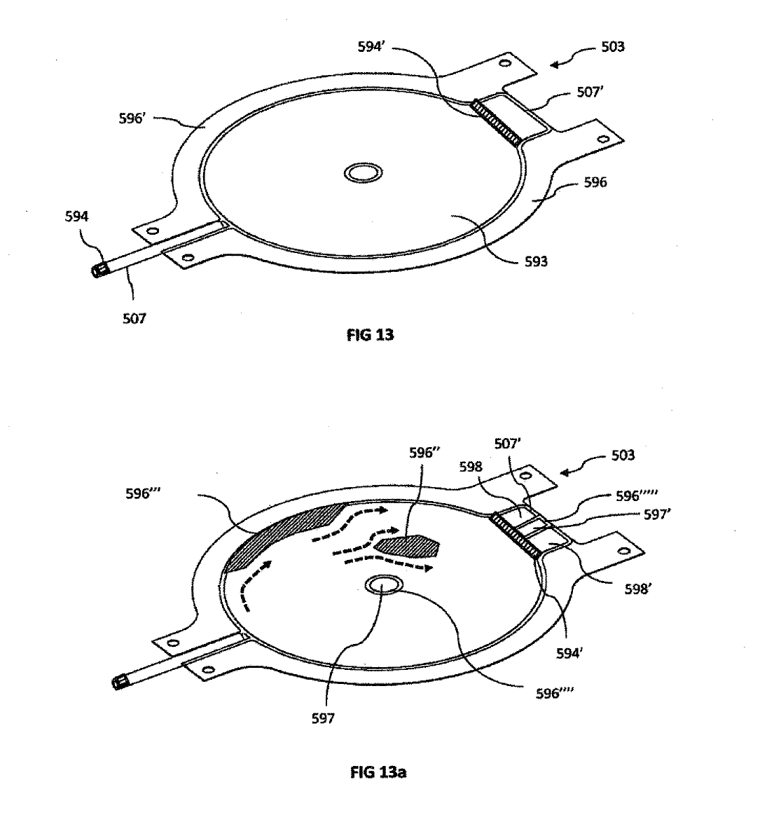

The thermoregulated device in accordance with a fourth embodiment of the invention, as illustrated by FIGS. 12a, 12b and 12c, includes a thermoregulated element 402 and a mixer 410, preferably in the form of a roller or circular volume turning freely on its revolution axis 409, retained by a rotary support 415 fixed to a motor. The reservoir 403, preferably being in whole or in part of curved, circular or oval shape, containing the preparation 404 and/or a fluid 405 is placed against the thermoregulated element 402, preferably of cylinder or disk shape or any other concave or convex shape enabling contact with the reservoir 403. The mixer 410 is preferably in contact with a bearing element 460, preferably in the form of a roller or circular volume turning freely on its revolution axis 409′ fixed to the rotary support 415 and pivoting about an axis 461 situated on the rotary support 415. The mixer 410 is placed so as to bear on the reservoir 403 and so as to form with the thermoregulated element 402 a local compression zone, preferably of rectilinear or straight shape, in the reservoir 403. The bearing element 460 also bears on the reservoir 403 so as to form with the thermoregulated element 402 a local compression zone in the reservoir 403. Openings 407, 407′ are preferably placed on either side of the reservoir 403 so as to be able to fill and to empty the content of the reservoir 403. The section of at least one of the openings 407′ is wide and preferably greater than 80 mm² so as to be able to extract the transformed mixture 406 from the reservoir rapidly and with less effort.

Optional obstructing elements 457, 457′ for closing or blocking the openings 407, 407′ are placed and actuated so as to be able to coordinate the filling and the emptying with the stirring/mixing of the content of the reservoir 403. One or more obstructing elements 457, 457′ preferably come to bear on one or more passages or outlet areas of the openings 407, 407′ as close as possible to the interior volume of the reservoir 403 so as to prevent some of the mixture (dead volume) remaining in the passage or passages or outlet area or areas of the openings 407, 407′ and not being moved/mixed by the mixer 410. This dead volume could then freeze and form a plug with a different consistency than the transformed mixture, degrading all or part of the extraction of the mixture and/or its quality.

When the motor turns, for example in the anticlockwise direction, the mixer 410 is moved relative to the reservoir 403 and entrains with it the bearing element 460, which creates a movement and a local acceleration of the preparation 404 and/or the fluid 405 in the reservoir 403 which has the effect of turning over, mixing and stirring/mixing the content of the reservoir at the same time as a thermal exchange is produced by the contact of the reservoir 403 with the thermoregulated element 402. The preparation 404 and/or the liquid 405 can therefore, in the same way as described above, be mixed and transformed into a mixture 406 in the form of ice or cold preparation.

A stopping or immobilizing element 470 is preferably placed so as to be able to stop or to immobilize the bearing element 460 near one of the openings 407′. When the motor turns in the opposite or clockwise direction and the stopping or immobilizing element 470 is activated, the mixer 410 pushes the content of the reservoir 403 in the form of mixture 406 toward the bearing element 460 which therefore moves it in the other direction until it comes to abut against the stopping or immobilizing element 470. An optional cutting element 480 placed in the vicinity of the opening 407′ is entrained by the bearing element 460 before the latter comes to abut against the stopping or immobilizing element 470. The cutting element 480 then comes to cut/section all or part of the reservoir 403, preferably in the area of the opening 407′. When the bearing element 460 is abutted against the stopping or immobilizing element 470, the cutting element 480 returns to its initial position with the assistance of a return element 481, preferably in the form of a spring. The cutting element 480 can be activated at any time provided that the reservoir has been placed in the system, so as to cut/section all or part of the reservoir 403 before, during or after the activation of the movement of the mixer 410 on the reservoir 403.

The mixture 406 can then be expelled out of the reservoir 403 when the obstructing element 457′ frees the opening 407′. The obstructing element may be activated and deactivated mechanically by the movement of the bearing element 460. The obstructing element or elements 457, 457′ can take various forms such as for example a bearing element, a pinching element or a valve actuated mechanically, electromechanically, manually or automatically.

The height over which the mixer 410 bears on the reservoir 403 can be adjusted so as to push some or all of the mixture 406 contained in the reservoir 403 during the movement of the mixer element. The opening 407 may be pierced mechanically when the reservoir 403 is introduced into the system or by fluid pressure introduced into the opening 407. The stopping or immobilizing element 470 may take the form of a ratchet enabling the movement of the bearing element 460 in one direction and automatically immobilizing it in the other direction. The interior volume of the reservoir 403 preferably takes the form of a circular volume or a flattened torus in order to prevent crushing of part of the mixture 406 by the rotary support 415 bearing on it.

This embodiment of the invention offers the possibility of increasing the speed of the mixture 406 because the mixer 410 can rotate faster than the reciprocating movement. This solution is particularly suitable for reducing the overall size of the system by integrating the mixer 410 and the bearing element 460 onto the rotary support 415.

According to FIG. 12b, the length R of the mixer 410 that comes to bear on the reservoir 403 is preferably greater than the maximum bearing distance L of the interior volume of the reservoir 403 between its two opposing faces so that the mixer 410 travels over most or all of the projected area of the interior volume of the reservoir 403 relative to the thermoregulated element 402. In this way, the mixture 406 is entirely moved inside the reservoir 403 in order to render uniform the thermal exchange with the thermoregulated element 402 during stirring/mixing.

According to FIGS. 13 and 13a, the reservoir 503 is preferably of circular shape and made up of two plastic foils attached to each other at the edges preferably by heat or ultrasound welds 596, 596′. The opening 507 is preferably in the form of a plastic tube welded between the foils of the reservoir 503 so as to create a passage between the interior volume of the reservoir 593 and the outside of the reservoir 503. The opening 507 preferably includes a closing element 594 that can be pierced, detached or peeled off making it possible to introduce fluid into the reservoir when using the reservoir with the device in accordance with the invention. The opening 507′ preferably includes a closing element 594′ that can be pierced, detached or peeled off making it possible to extract fluid or the preparation from the reservoir when the reservoir is used with the mixture transformation system. The element 594′ of the reservoir 503 preferably opens automatically, in accordance with the principle explained above, when the pressure exerted by the mixer element on the preparation is sufficient to open the closing element 594′. Thus the preparation can be extracted from the reservoir 503 without having to cut the opening 507′.

Welds 596″, 596′″, 596″″ may optionally be placed on the reservoir so as to form constricted areas in the reservoir so as to improve the turbulence and the agitation of the preparation during the process of transformation of the mixture. The weld 596″ may also serve as a bearing area for the mixer element, thereby avoiding some of the mixture being placed under the support.

The surface 597 of the reservoir situated inside the weld 596″″, preferably placed at the center of the reservoir 503, can be cut on introducing the reservoir 503 into the device by a cutting element (not shown) situated on the thermoregulated element or the lid of the device. The surface 597 may also be precut. The opening or hole formed in this way in the surface 597 is isolated from the content of the reservoir and makes it possible to pass a guide or a detection element through the reservoir without contact with the content of the reservoir.

At least one weld 596″″″ may optionally be placed in the opening 507′ so as to form a surface 597′ making it possible to create at least two outlet passages 598, 598′ intended to confer a specific profile on the composition. The surface 597′ of the outlet of the reservoir situated inside the weld 596″″″, preferably placed adjacent the closing element 594′ of the reservoir 503, can be cut on introducing the reservoir 503 into the device by a cutting element (not shown) situated on an obstructing element or the lid of the device. The surface 597′ may also be precut. The opening or hole formed in this way in the surface 597′ is isolated from the content of the reservoir and makes it possible to pass a guide or a detection element through the outlet of the reservoir without contact with the content of the reservoir.

The welds 596″″, 596″″″ may be replaced by any element for fastening the faces of the reservoir 503 such as, for example, a ring, annulus or structure forming a surface 597, 597′ isolated from the content of the reservoir 503. The welds 596, 596′, 596″, 596′″ may be replaced by any means for fastening the faces of the reservoir 503 such as, for example, glue, a plastic structure or any system attaching the two faces of the reservoir 503 to each other.

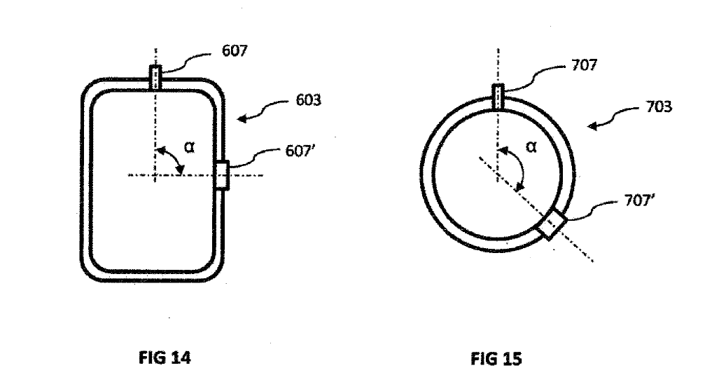

According to FIGS. 14 and 15, the openings 607, 607′ and 707, 707′ of the reservoir 603 and 703 may be placed relative to one another at an angle α between 20 and 180° inclusive. This disposition of the openings moreover makes it possible to facilitate the insertion of the reservoir into the device in the chosen configuration for the placing and retention of the reservoir on actuation of the device.

According to a number of variant embodiments of the invention, the following modifications and/or additions may be made to the various embodiments as described above:
the carriage 14 and the support 15 may be adapted in such a way as to be able to combine a rotary and linear movement of the mixer 10 relative to the reservoir 3 placed against on the thermoregulated element 2;
the reservoir 203 and the mixer 210 may be placed outside the thermoregulated element 202;
the reservoir 203 and the thermoregulated element 202 may have a conical shape;
the reservoir may be compartmented in such a manner as to have a plurality of components of the mixture separated in compartments isolated from one another. The device may be adapted to cause the compartments to communicate with one another before, during or after the transformation process described above;
the reservoir includes a closing or opening system such as for example a stuck-on flap, a clip-on flap, a zip, a sealed detachable element, a stopper, a peelable element or heat-weld or one of any other kind enabling extraction of the transformed mixture without tearing or cutting the reservoir;
the mixer may be removable;
the mixer and/or the thermoregulated element may have a profile with at least one groove, recess, cavity, increased thickness or any other particular shape in such a manner as to create a specific, regular or irregular movement of the mixture inside the reservoir;
the mixer may be produced in a number of parts in such a manner as to bear on a plurality of areas of the reservoir in order to create a specific or irregular movement of the mixture inside the reservoir;
a plurality of mixers may be placed in such a manner as to create movements bearing on the reservoir in accordance with circular, transverse, lateral, oblique or vertical trajectories or combinations thereof in order to create a flow of the content from the reservoir before, during or after the thermal exchange between the reservoir and at least one thermoregulated element;
the thermoregulated element may be pierced or splined in such a manner as to allow the flow of the water resulting from the condensation of the surrounding air on the thermoregulated element;
the thermoregulated element may be placed vertically in such a manner as to facilitate the flow of the water resulting from the condensation of the surrounding air on the thermoregulated element;
the device may be adapted in such a manner as to place a plurality of reservoirs on the thermoregulated element in order to prepare a plurality of mixtures at the same time. For example, an ice may be obtained with two flavors each produced in a separate reservoir and extracted simultaneously or sequentially into a container placed facing the openings of the reservoirs;
the device may be adapted to extract the mixture into a plurality of containers disposed on a turntable or any other conveyor moved automatically or manually;
the reservoir may be produced in different types of plastic or other flexible or part-flexible material, preferably recyclable, biodegradable and/or of foodstuffs grade. It may also be made of metal or partially metalized in order to increase its thermal conductivity and to reduce its thickness. The surface of the reservoir may be a material or coated with a material reducing the risk of ice sticking it to the thermoregulated element;
the reservoir may be prefilled with a mixture ready to use necessitating no addition of fluid or preparation before being placed in the system;
the reservoir may include a frame, a structure or a rigid or semi-rigid element facilitating its storage, its manipulation, its insertion in and/or its extraction from the device in accordance with the invention;
the frame, structure or element may integrate and/or form accessory functions of the reservoir such as a clasp, a cutter, a spout, a scraper, a pusher, a fixing clip or support, a label, a barcode, an RFID tag, a position poka yoke, a hinge, a handle or any other element intended to facilitate the storage, transportation, manipulation, filling, emptying, use and recycling of all or part of the reservoir;
the frame, structure or element may be intended to confer a predefined shape or a variable shape on the reservoir such as for example a cylinder or a cone by winding of that element;
the frame, structure, element, any part of the reservoir or connector (17) may be intended to transmit identification information as to the type of reservoir and/or of adaptation of one or more operating parameters of the device, such as for example the volume of fluid to be introduced into the reservoir, the mixing time, the temperature of the thermoregulated element, starting or stopping of the device;
the frame, structure, element, any part of the reservoir or connector (17) may transmit information to the device or to equipment including the device relating to a shape, a color, a temperature, a transparency, a wave reflection, a wave absorption or of any other kind that can be identified and/or transmitted by means of one or more mechanical, electronic, electromechanical or chemical sensors and/or transmitters;
the thermoregulated element may be cooled or heated by any thermal transfer method including notably gas or liquid refrigerant fluids, a chiller system comprising a compressor, thermoelectric elements such as “Peltier” modules, heating bodies or of any other type;
the overall size of the device may be significantly reduced by using a refrigerant gas chilling system comprising an oil-free compressor of Embraco “Wisemotion” type or any other similar type;
the preparation, the liquid or the mixture may be introduced separately or together into the reservoir, which is preferably empty, before, during or after its insertion in the device;
the reservoir may be filled in a vacuum or in a conditioned atmosphere in such a manner as to optimize the shelf life of the preparation, to reduce the volume of the reservoir and to ensure the conditioning of the content in accordance with sanitary or other standards before its use;
the reservoir may be entirely or partially transparent in such a manner as to be able to identify the content and its state before, during and after its use;
the reservoir may take the form of a plastic sachet or bag formed of films ultrasound welded or heat welded or stuck together;
the reservoir may have no opening and contain the mixture to be transformed in a prefilled manner, ready for use. Once transformed, the mixture may be extracted by tearing, cutting or opening all or part of the reservoir, manually or automatically;
a labeling system in barcode, color code or RFID tag form may be placed on the reservoir in order for the system to be able to identify the reservoir automatically and command filling, mixing, the temperature of the thermoregulated element and emptying in accordance with preprogrammed parameters;
the device may be adapted to be controlled via an electronic interface programmable by the user or preprogrammed so as to be able to adapt some or all of the parameters of the method of transforming the mixture;
the device may be adapted to add or to remove fluids such as air for example to or from the reservoir in such a manner as to modify the composition of the mixture and thereby obtain at will variants in terms of quality, taste and texture;
all or part of the control of the adjustment elements of the device may be effected manually or automatically;
the device may integrate a de-icing element facilitating the removal of the flexible reservoir from the thermoregulated element;
the device may be adapted to integrate control electronics with or without a screen, with or without buttons, with or without a microphone, with or without a sound generator such as loudspeakers or buzzer, with or without indicator lights;
the device may be adapted to integrate temperature, moisture, pressure, closure sensors or sensors of any other type used to monitor and to control the operation of the device;
the device may be adapted to communicate by wire or wirelessly with at least one external device in such a manner as to transmit and to receive information on the operation of the device, to update software components of the device, to diagnose malfunctions, to send orders to an electronic store, to transmit or to receive operating instructions. All of the electric and electronic components of the device may be connected to, monitored and controlled by control electronics;
the mixer may also be thermoregulated in such a manner as to reduce the time to transform the mixture;
the device may be adapted to chill or to heat water or a fluid before, during or after its introduction into the reservoir;
the device may be adapted to chill or to heat at least one container facing one of the openings of the reservoir and receiving the transformed mixture;
the device may be adapted to add other fluids, solid substances or semi-solid substances to the mixture extracted from the reservoir, such as for example chocolate, sweets, Chantilly cream, caramel, etc;
the thermoregulated element may be mobile in such a manner as to create a relative movement with the mixer making it possible to carry out the transformation process in the same manner as described above in accordance with any of the variants described; and
the device may be integrated into any type of equipment intended to transform a mixture, preferably in the form of an ice machine producing portions to be consumed at the place where the mixture is transformed.

Although a number of embodiments of the invention have been described, there exist other variants that are not described. The scope of the invention is therefore not limited to the embodiments described above.

1.-55. (canceled)

56. A thermoregulated device for modifying a consistency of a starting composition that includes a preparation which is at least partially mixed with a liquid, said device comprising:
a reservoir having an interior for containing the starting composition and having two opposing faces, at least one of faces comprising a flexible section;
a thermoregulated element having a predefined contact surface adapted for contacting one of the two faces of the reservoir; and
a stirring unit configured to mix the composition in the reservoir, with a temperature of the composition being modified as a result of conduction with the thermoregulated element, as the composition is mixed, to produce a final composition of transformed consistency, said stirring unit comprising a mixer, and driving unit configured move the mixer against the flexible section of the reservoir, when the reservoir is disposed on the thermoregulated element, so as to establish a local compression zone in the interior of the reservoir, said driving unit being configured to then move the mixer with respect to the flexible section of the reservoir so as to move the local compression zone inside the reservoir in such a way as to mix the composition contained in the interior of the reservoir during mixing operation.

57. The thermoregulated device of claim 56, wherein the preparation includes a substance in powder form.

58. The thermoregulated device of claim 56, wherein the mixer and the thermoregulated element are configured so as to be movable relative to each other from an open configuration, in which the thermoregulated element is accessible to receive the reservoir, to a closed configuration in which the mixer bears on the flexible section of the reservoir.

59. The thermoregulated device of claim 56, wherein the local compression zone is substantially rectilinear.

60. The thermoregulated device of claim 56, wherein the mixer is of elongate shape and has a length sufficient to bear on the reservoir and corresponding to at least 90% of a maximum bearing distance of a volume of the interior of the reservoir so that the local compression zone is substantially rectilinear and extends between two opposite sides of the reservoir.

61. The thermoregulated device of claim 56, wherein the driving unit is configured to move the mixer along a surface which is substantially parallel to a contact surface of the thermoregulated element.

62. The thermoregulated device of claim 56, further comprising a positioning system configured to adjust a distance between a contact surface of the mixer and the contact surface of the thermoregulated element so as to enable variation of the distance before, during or after the mixing operation.

63. The thermoregulated device of claim 62, wherein distance is between 0.2 mm and 10 mm.

64. The thermoregulated device of claim 56, wherein the mixer is in the form of a circular body, preferably a roller, arranged to pivot freely about its axis of revolution so that the mixer is capable to roll on the flexible section of the reservoir.

65. The thermoregulated device of claim 56, wherein the driving unit is configured to impart a to-and-fro movement to the mixer before, during or after the mixing operation.

66. The thermoregulated device of claim 56, wherein the driving unit is configured to move the mixer bearing on the reservoir so as to extract from it the final corn position of transformed consistency.

67. The thermoregulated device of claim 58, further comprising a thermoinsulating element, preferably in the form of a membrane, movable relative to the thermoregulated element when moving from the open configuration to the closed configuration.

68. The thermoregulated device of claim 67, wherein the thermoinsulating element is configured to cover the face of the reservoir in opposition to the face in contact with the thermoregulated element, when the reservoir is disposed on the thermoregulated element and the device is moved to the closed configuration.

69. The thermoregulated device of claim 67, wherein the thermoinsulating element is configured to cover the face of the reservoir including the flexible section, when the reservoir is disposed on the thermoregulated element and the device is moved to the closed configuration.

70. The thermoregulated device of claim 56, wherein the thermoinsulating element is deformable by the mixer.

71. The thermoregulated device of claim 56, further comprising an injection system for injecting a fluid into the reservoir, said system including a fluid reservoir communicating with a fluid passage for connection to an opening of the reservoir.

72. The thermoregulated device of claim 71, wherein the injection system includes a heat exchanger placed in the proximity of or against all or part of the fluid passage and/or the fluid reservoir in such a manner as to be able to control a temperature of the fluid before and during its introduction into the reservoir.

73. The thermoregulated device of claim 56, further comprising a chilling system or a heating body in contact with the thermoregulated element.

74. The thermoregulated device of claim 56, further comprising a base on which the thermoregulated element is arranged, and a lid configured to include the stirring unit and the driving unit.

75. The thermoregulated device of claim 74, wherein the lid is mounted to pivot relative to the base so that the device is able to move from a deployed configuration to receive the reservoir to a closed configuration in which the mixer at least partially compresses the flexible section of the reservoir.

76. The thermoregulated device of claim 56, further comprising a support moveable by the driving unit so that the mixer is moveable relative to a plane surface in substantial parallel relationship to the contact surface of the thermoregulated element, said mixer being mounted to pivot in the support.

77. The thermoregulated device of claim 76, further comprising a lid configured to include the stirring unit, and the driving unit, a positioning member connected to the support, and an actuator connecting the lid to the support, said actuator cooperating with the positioning member in such a manner as to move the support, when the actuator is activated along an axis perpendicular to the plane surface so as to adjust a pressure exerted by the mixer on the flexible section of the reservoir, when the reservoir is disposed on the thermoregulated element.

78. The thermoregulated device of claim 56, wherein the thermoregulated element is a circular, preferably cylindrical, solid configured to receive a face of the flexible section of the reservoir on at least a part of its internal circumference, said mixer configured to contact the opposing face of the flexible section of the reservoir so as to form with the thermoregulated element the local compression zone, said driving unit being configured to drive the mixer along a surface substantially concentric with the thermoregulated element.

79. A machine for the fabrication of a cold preparation, in particular milkshake, ice or ice cream, said machine comprising a thermoregulated device comprising a reservoir having an interior for containing the starting composition and having two opposing faces, at least one of faces comprising a flexible section, a thermoregulated element having a predefined contact surface adapted for contacting one of the two faces of the reservoir, and a stirring unit configured to mix the composition in the reservoir, with a temperature of the composition being modified as a result of conduction with the thermoregulated element, as the composition is mixed to produce a final composition of transformed consistency, said stirring unit comprising a mixer, and driving unit configured move the mixer against the flexible section of the reservoir, when the reservoir is disposed on the thermoregulated element, so as to establish a local compression zone in the interior of the reservoir, said driving unit being configured to then move the mixer with respect to the flexible section of the reservoir so as to move the local compression zone inside the reservoir in such a way as to mix the composition contained in the interior of the reservoir during mixing operation.

80. A thermoregulated device for modifying a consistency of a starting composition that comprises a preparation at least partially mixed with a liquid, said device comprising:
a reservoir containing a starting composition and having two opposing faces, at least one of the faces comprising a flexible section;
a thermoregulated element having a predefined contact surface adapted for contacting one of the faces of the reservoir;
a stirring unit configured to mix the composition in the reservoir, with a temperature of the composition being modified as a result of conduction with the thermoregulated element, as the composition is mixed, to produce a final composition of transformed consistency; and
a thermoinsulating element configured for movement relative to the thermoregulated element.

81. The thermoregulated device of claim 80, wherein the thermoinsulating element is adapted to cover the face of the reservoir opposite the face in contact with the thermoregulated element, when the reservoir is disposed on the thermoregulated element and the device moves to a closed configuration.

82. The thermoregulated device of claim 80, wherein the thermoinsulating element is adapted to cover the face of the reservoir including the flexible section, when the reservoir is disposed on the thermoregulated element and the device moves to a closed configuration.

83. The thermoregulated device of claim 80, wherein the thermoinsulating element is configured in the form of a membrane deformable by the mixer.

84. A machine for the fabrication of a cold preparation, in particular milkshake, ice or ice cream, comprising a thermoregulated device a reservoir containing a starting composition and having two opposing faces, at least one of the faces comprising a flexible section, a thermoregulated element having a predefined contact surface adapted for contacting one of the faces of the reservoir, a stirring unit configured to mix the composition in the reservoir, with a temperature of the composition being modified as a result of conduction with the thermoregulated element, as the composition is mixed, to produce a final composition of transformed consistency, and a thermoinsulating element configured for movement relative to the thermoregulated element.

85. A method for operating a thermoregulated device for modifying the consistency of a starting composition, comprising:
activating the thermoregulated device;
modifying a temperature of the thermoregulated element;
positioning a reservoir in contact with the thermoregulated element, with the reservoir having at least one flexible section and containing the starting composition;
moving a mixer so as to bear on the flexible section of the reservoir in such a way as to create a local compression zone inside the reservoir;
moving the mixer relative to the flexible section of the reservoir so as to move the local compression zone inside the reservoir in such a way as to mix the composition in the reservoir during a mixing operation; and
extracting a final composition of transformed consistency from the reservoir.

86. The method of claim 85, wherein the thermoregulated element is chilled to a temperature below −20° C.

87. The method of claim 85, further comprising placing a thermoinsulating element in contact with the reservoir.

88. The method of claim 85, further comprising adding fluid to or removing fluid from the reservoir before, during or after the mixing operation.

89. The method of claim 85, further comprising imparting to the mixer a predefined speed of movement at the start of the mixing operation and then decreasing, preferably progressively, the speed of movement of the mixer during the mixing operation.

90. The method of claim 85, further comprising modifying a distance between a contact surface of the mixer and a contact surface of the thermoregulated element before, during or after the mixing operation.

91. The method of claim 85, wherein the distance is progressively increased during the mixing operation.

92. The method of claim 85, further comprising reversing a direction of movement of the mixer before, during or after the mixing operation.

93. A reservoir for a thermoregulated device for modifying a consistency of a starting composition, in particular for the fabrication of milkshake, ice or ice cream, said reservoir containing a starting composition and comprising:
two opposing faces with substantially identical dimensions having an area between 70 cm² and 600 cm² inclusive, preferably between 150 cm² and 200 cm² inclusive, at least one face including at least one flexible section, one of the two opposing faces adapted for contacting a thermoregulated element;
a first opening configured for connection to a fluid passage; and
a second opening configured to enable extraction from the reservoir of a final composition of transformed consistency.

94. The reservoir of claim 93, further comprising first and second occlusion elements for sealing the first and second openings, respectively, said first occlusion element being configured to clear the first opening so as to allow a fluid to enter the reservoir whilst the second occlusion element is configured to clear the second opening as soon as a predefined pressure threshold is reached inside the reservoir at a level of the second occlusion element so as to allow the extraction from the reservoir of the final composition of transformed consistency.

95. The reservoir of claim 93, further comprising a connector received in the first opening for connection to the fluid passage, said connector including an element adapted to transmit information or an identifier to the thermoregulated device.

96. The reservoir of claim 93, wherein the second opening has an area of at least 80 mm².

97. The reservoir of claim 93, wherein the second opening has a width which is at least 15 mm.

98. The reservoir of claim 93, further comprising a thermoinsulating element disposed on one of the opposing faces.

99. The reservoir of claim 93, wherein the first and second openings define there between an angle between 20° and 180° inclusive, the angle preferably being 180°.

100. The reservoir of claim 93, further comprising a surface at the level of the second opening, said surface being isolated from a content of the reservoir and configured to receive a guide or a detection element.

101. The reservoir of claim 93, wherein the reservoir has a circular shape and a surface at its center, said surface being isolated from a content of the reservoir and configured to receive at its center a guide or a detection element.

102. The reservoir of claim 93, wherein the reservoir is formed by two plastic films attached to each other.

103. The reservoir of claim 93, wherein the reservoir has a thickness which is equal to or less than 10 mm, when containing the starting composition.

104. A prefilled reservoir for a thermoregulated device for modifying the consistency of a starting composition, in particular for the fabrication of milkshake, ice or ice cream, said reservoir containing a starting composition and comprising:
two opposing faces with substantially identical dimensions having an area between 70 cm² and 600 cm² inclusive, preferably between 150 cm² and 200 cm² inclusive, at least one face including at least one flexible section, one of the two opposing faces being adapted for contacting a thermoregulated element;
an opening; and
an occlusion element configured to seal the opening, said occlusion element being configured to clear the opening as soon as a predefined pressure threshold is reached inside the reservoir at a level of the occlusion element so as to allow extraction from the reservoir of a final composition of transformed consistency.

105. The prefilled reservoir of claim 104, wherein the opening has an area of at least 80 mm².

106. The prefilled reservoir of claim 104, wherein the opening has a width which is at least 15 mm.

107. The prefilled reservoir of claim 104, wherein the reservoir is formed by two plastic films.

108. The prefilled reservoir of claim 107, wherein the two plastic films are fastened together in such a manner that the reservoir has a substantially circular volume.

109. The prefilled reservoir of claim 104, further comprising a surface at a level of the opening, said surface being isolated from a content of the reservoir and configured to receive a guide or a detection element.

110. The prefilled reservoir of claim 104, wherein the reservoir has a circular shape and a surface at its center, said surface being isolated from a content of the reservoir and configured to receive at its center a guide or a detection element.
